(19) United States
(12) Patent Application Publication
(10) Pub. No.: US 2014/0229504 A1
(43) Pub. Date: Aug. 14, 2014

(54) SYSTEM AND METHOD FOR MANAGING DATABASE IN DATA DISTRIBUTION SERVICE

(71) Applicant: SAMSUNG TECHWIN CO., LTD., Changwon-city (KR)

(72) Inventors: Su-young KIM, Changwon-city (KR); Chang-Suk YOON, Changwon-city (KR); Mi-ju PARK, Changwon-city (KR)

(21) Appl. No.: 13/937,251

(22) Filed: Jul. 9, 2013

(30) Foreign Application Priority Data
Feb. 12, 2013 (KR) 10-2013-0014973

(51) Int. Cl. G06F 17/30

(52) U.S. Cl. CPC G06F 17/30545
USPC 707/770

(57) ABSTRACT

Exemplary embodiments may disclose a system which manages a database in a data distribution service (DDS) in which a plurality of nodes connected to each other through a network are subscribed to the DDS for at least one topic, the system comprising: a first agent configured to be positioned at a first node, among a plurality of nodes, configured to receive a control request for the database from a user application operating in the first node, and transmit the control request to at least one node subscribed to a topic registered for the first node; a second agent configured to be positioned at a second node, which is different from the first node, receive the transmitted control request, control a database table according to the topic on a basis of the received control request, and transmit a result of controlling the database table to the first node.

### CROSS-REFERENCE TO RELATED PATENT APPLICATION

This application claims priority from Korean Patent Application No. 10-2013-0014973, filed on Feb. 12, 2013, in the Korean Intellectual Property Office, the disclosure of which is incorporated herein in its entirety by reference.

### BACKGROUND

1. Field

Exemplary embodiments relate to a system and method for managing a database in a data distribution service. More particularly, exemplary embodiments relate to a system and method for processing a request for controlling a database by an agent in a data distribution service, in which a plurality of nodes connected to each other through a network are respectively subscribed to the data distribution service for at least one or more topics, among a plurality of topics.

2. Description of the Related Art

In a related art environment, multiple devices may be dynamically linked with each other to form a single network domain, and exchange data with each other. In this related art environment, it is more efficient to use an N:N communication scheme, in which devices participating in a domain are equal, rather than a server/client communication scheme using a central server. The object management group (OMG) of the related art releases a data distribution service (DDS), which is a standard communication middleware providing efficient data distribution with a publish/subscribe communication scheme in the related art environment. In the related art environment, a network domain is dynamically formed and free participation/withdrawal of a device is enabled. By using the related art DDS, a system, such as a weather information service system, a traffic network management service system, or a battle management system, which is formed by linking multiple devices with each other, may be efficiently enabled to be designed/implemented/operated.

However, the related art DDS system focuses on a configuration and an operation of a publisher, which creates and publishes data, and a subscriber, which consumes subscribed data. In the related art DDS system, since a user is required to directly participate in a DDS network to publish or subscribe data, the DDS system is difficult to apply to a high capacity data processing.

In particular, when a DDS system of the related art is directly connected from user applications, and when a portion of a database is changed or updated, all of the user applications are required to be amended, or all nodes subscribed to the DDS are required to be notified of the change or update.

### SUMMARY

Exemplary embodiments may provide a system and method for managing a database in a data distribution service (DSS) for controlling a database through a DDS agent to notify only nodes requesting changing or updating the database, instead of all the nodes subscribed to the DDS, as a result of the change or the update of the database without affecting user applications using the DDS, when the database is changed or updated.

Exemplary embodiments are not limited thereto, and additional advantages and features will be set forth in part in the description which follows, and in part will become apparent to those having ordinary skill in the art upon examination of the following or may be learned from practice of the exemplary embodiments.

According to an aspect of the exemplary embodiments, there is provided a system which manages a database in a data distribution service (DDS), in which a plurality of nodes connected to each other through a network are subscribed to the DDS for at least one topic, among a plurality of topics, the system including: a first agent configured to be positioned at a first node, among the plurality of nodes, receive a control request for the database from a user application operating in the first node, and transmit the control request to at least one node subscribed to a topic registered for the first node; a second agent configured to be positioned at a second node, receive the transmitted control request, control a database table according to the topic on a basis of the received control request, and transmit a result of controlling the database table to the first node.

The first agent may be further configured to convert the control request into a request message of a format predefined on the DSS, and transmit the converted request message to the at least one node subscribed to the topic registered for the first node.

The request message may include: type information, which is information on a type of the request message; and method information on a call method included in an application programming interface (API), which is embedded in the second node, the call method is allowed to be called by the second agent.

When the request message type is persist, the second agent may add the method information to a queue, which corresponds to an identifier of the first node and the database table.

When the request message type is commit and the method information exists in a queue, which corresponds to an identifier of the first node and the database table, the second agent may perform a change on the database table corresponding to the topic according to the method information.

When the request message type is cancel and the method information exists in a queue, which corresponds to an identifier of the first node and the database table, the second agent may cancel the method information from the queue.

When the request message type is read and the method information exists in a queue, which corresponds to an identifier of the first node and the database table, the second agent may read data stored in the database table corresponding to the topic according to the method information.

When the request message type is command and the method information exists in a queue, which corresponds to an identifier of the first node and the database table, the second agent may perform controls on the database table corresponding to the topic according to the method information.

The method information may include a name and factor of the call method, and data necessary to perform the call method, which is included in the API and is allowed to be called by the second agent, the API being embedded in the second node.

The second agent may be further configured not to transmit the result of the controlling the database table to a node which has not transmitted the control request to the at least one node subscribed to the topic registered for the first node.

According to another aspect of the exemplary embodiments, there is provided a method of managing a database in a data distribution service (DDS) in which a plurality of nodes connected to each other through a network are subscribed to the DDS for at least one topic, among a plurality of topics, the method including: receiving, by a first agent configured to be positioned at a first node, among a plurality of nodes, a control request for the database from a user application operating in the first node; transmitting, by the first agent, the control request to at least one node which is subscribed to a topic registered for the first node; receiving, by a second agent configured to be positioned at a second node, the transmitted control request; controlling, by the second agent, a database table corresponding to the topic on a basis of the received control request; and transmitting a result of controlling the database table to the first node.

The first agent is further configured to convert the control request into a request message of a format predefined on the DSS, and transmit the converted request message to the at least one node subscribed to the topic registered for the first node.

The request message may include: type information, which is information on a type of the request message; and method information on a call method included in an application programming interface (API), which is embedded in the second node, the call method is allowed to be called by the second agent.

When the request message type is persist, the controlling may include adding the method information to a queue, which corresponds to an identifier of the first node and the database table.

When the request message type is commit and the method information exists in a queue, which corresponds to an identifier of the first node and the database table, the controlling may include performing a change on the database table corresponding to the topic according to the method information.

When the request message type is cancel when the method information exists in a queue, which corresponds to an identifier of the first node and the database table, the controlling may include cancelling the method information from the queue.

When the request message type is read and the method information exists in a queue, which corresponds to an identifier of the first node and the database table, the controlling may include reading data stored in the database table corresponding to the topic according to the method information.

When the request message type is command and the method information exists in a queue, which corresponds to an identifier of the first node and the database table, the controlling may include performing controls on the database table corresponding to the topic according to the method information.

The method information may include a name and factor of the call method, and data necessary to perform the call method, which is included in the API and is allowed to be called by the second agent, the API being embedded in the second node

The second agent may be further configured not to transmit the result of the controlling the database to a node which has not transmitted the control request to the at least one node subscribed to the topic registered for the first node.

### BRIEF DESCRIPTION OF THE DRAWINGS

The above and other features and advantages of the exemplary embodiments will become more apparent by describing in detail exemplary embodiments thereof, with reference to the attached drawings in which:

FIGS. 1A and 1B schematically illustrate the related art DDS and a DDS according to the exemplary embodiments, respectively;

FIG. 2 is a block diagram schematically illustrating a configuration of a database management system in a DDS according to an embodiment of the exemplary embodiments; and

FIGS. 3A to 3E illustrate examples of controlling a database according to request message types in a DDS according to an embodiment of the exemplary embodiments.

### DETAILED DESCRIPTION

The detailed description exemplifies the principle of the exemplary embodiments. Although the description of the principle may not be clear or all possible embodiments of the exemplary embodiments are not illustrated in the specification, those skilled in the art can embody the principle and invent various apparatus within the scope and concept of the exemplary embodiments from the description. Also, all the conditional terms and embodiments described in the specification are intended to make the concept of the exemplary embodiments clear, in principle, and the exemplary embodiments should be understood as not limited to only the described embodiments or conditions. Also, all of the detailed descriptions on a particular embodiment as well as the principle, view points and embodiments should be understood to include structural and functional equivalents. Those equivalents should he understood to include those currently known and to be developed in future. In other words, they include all devices developed to perform the function of the element disclosed in the exemplary embodiments, regardless of their structures.

The functions of elements illustrated in the drawings including a functional block, marked as a processor, or a similar concept of the processor can be provided not only by a dedicated hardware, but also by using hardware capable of executing proper software that can perform the functions. When the functions of elements are provided by a processor, the processor can be a single processor dedicated to only that function, a single shared processor, or a plurality of individual processors, part of which can be shared. In addition, the apparent use of terms such as processor, controller, or terms having similar concept should not be exclusively construed to be hardware capable of executing software, but include may include a digital signal processor (DSP) hardware, ROM, RAM and non-volatile memory for recording software implicitly. Other known or commonly used hardware can be included.

Other objects and aspects of the exemplary embodiments will become apparent from the following description of the embodiments with reference to the accompanying drawings. Like reference numerals designate like elements throughout the specification. Also, any description that may unnecessarily obscure the essence of the exemplary embodiments is omitted from the detailed description.

In the specification, unless explicitly described to the contrary, the word “comprise” will be understood to imply the inclusion of stated elements, but not the exclusion of any other elements.

Expressions such as “at least one of,” when preceding a list of elements, modify the entire list of elements and do not modify the individual elements of the list.

Hereinafter, preferred embodiments will be described with reference to the accompanying drawings.

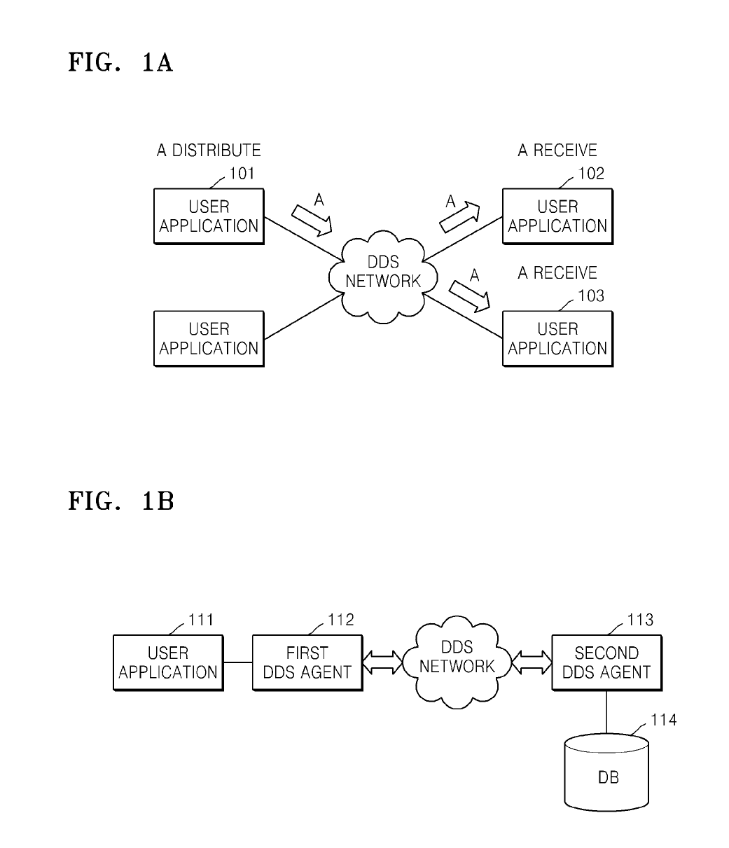

FIGS. 1A and 1B schematically illustrate the related art DDS and a DDS according to the exemplary embodiments, for comparison.

Referring to FIG. 1A, the related art DDS operates such that, when a user application 101 in one of a plurality of nodes publishes a message having a topic “A” through the DDS, all user applications 102 and 103 in the nodes, which are subscribed to topic “A”, receive the corresponding message. The same process occurs when a database is changed or updated. For example, when a node for which a topic “A” is registered, updates content corresponding to the topic “A” in the database, the node notifies other nodes registered for the topic “A” of this update result. In the related art an excess traffic increase occurs in a network which connects the related art DDS nodes.

Referring to FIG. 1B, according to a DDS of the exemplary embodiments, a user application 111 in one node, of a plurality nodes, is not directly connected to the DDS. The user application 111 transfers a control request for a database in the DDS to a first DDS agent 112, which is in the same node with the user application 111.

The first DDS agent 112 receives the control request for the database in the DDS from the user application 111, which is operating in the same node, and converts the control request into a request message having a predefined format in the DDS.

At this time, the control request may be converted into the request message having a message structure of the predefined format, according to a DB interface definition language (IDL) code shared on the DDS, and the request message may have a bytecode type that DDS agents in all of the nodes subscribed to the DDS can read.

The first DDS agent 112 searches topics registered for the node at which the user application 111 issuing the control request positions, e.g., a node at which the first DDS agent 112 positions, and transmits the converted request message to another node which is subscribed to the corresponding topic.

A second DDS agent 113 positions at the other node subscribed to the corresponding topic, receives the request message, which is transmitted by the first DDS agent 112, controls a database table 114 corresponding to the corresponding topic according to the request message, and transmits the control result only to a node which has transmitted the request message, instead of all of the nodes which register for the corresponding topic.

Accordingly, when the database is managed through the DDS agent according to the exemplary embodiments, only a node requesting changing or updating a database, instead of all nodes subscribed to the DDS, can be notified of a result of the change or the update of the database, without affecting user applications using the DDS, when the database is changed or updated.

For example, in contrast with the related art shown in FIG. 1A, when a node subscribed to the topic “A” updates content corresponding to the topic “A” in a database, only a DDS agent in a node which has requested the corresponding update can be notified of the update result. Therefore, traffics of a network connecting the nodes, which participate in the DDS, may be efficiently managed.

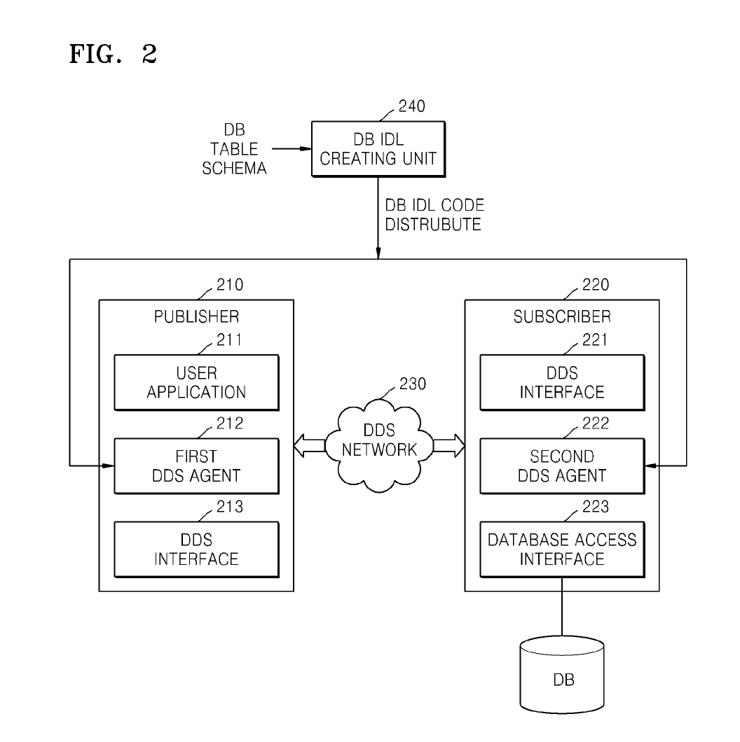

FIG. 2 is a schematic block diagram illustrating a database managing system in a DDS according to an embodiment.

Referring to FIG. 2, a database managing system in a DDS according to an embodiment may include a publisher 210 and a subscriber 220. In the present embodiment, the publisher 210 and the subscriber 220 respectively correspond to two nodes performing functions of publisher and subscriber in a corresponding embodiment, among a plurality of nodes subscribed to the DDS.

In the present embodiment, the publisher 210 and the subscriber 220 are only an embodiment for convenience of description. The publisher 210 may include a plurality of nodes, the subscriber 220 may include a plurality of nodes, or both of them may include a plurality of nodes. This is obvious in comparison to the distributed database service or the related DDS, and the exemplary embodiments are not limited thereto.

The publisher 210 includes a user application 211, a first DDS agent 212, and a DDS interface 213.

The user application 211 transmits a control request for a database in the DDS to the first DDS agent 212.

At this time, the control request may include a request for changing a database state, such as insertion/deletion/change for data stored in the database, and a read request for data stored in the database, or a request not for changing the state of the database, such as a request for other information regarding a present state of the database.

The first DDS agent 212 receives the control request for the database for the DDS from the user application 211, and converts the same into a request message of a predefined request message in the DDS. At this time, a DB IDL code shared in the DDS may be referred to.

The DB IDL code shared in the DDS is created by a DB IDL creation apparatus 240 referring to a schema, which represents a database table structure of the DDS. The DB IDL code may be shared in advance by DDS agents in each of nodes subscribed to the DDS, or distributed to be shared in real time while the DDS is served. At this time, the DB IDL creating apparatus 240 may be subscribed to the DDS, may be positioned at any one node, among a plurality of nodes connected to each other through the DDS network 230, and may distribute the DB IDL code.

The DB IDL code created by the DB IDL creating apparatus 240 may declare a structure of a predetermined bytecode type as shown in Table 1 below:

TABLE 1

| Declaration | Content |
|---|---|
| string name; | a name of request |
| byte type; | a type of request |
| sequence <string, N> | a factor of request |
| sequence <DataType, M> | data of request |

Referring to Table 1, a request message created according to the DB IDL code of the present embodiment may include a name of request message, a type of request message, a factor of request message, or other data of request message. At this time, DataType, which defines a data type of other data of the request message, may be defined according a type of data stored in the database table, or an entity class definition of an object relational mapping (ORM) framework.

According to implemented examples, the corresponding request message may directly include information on a call method included in an API of a database access interface 223. In this case, a name, a factor, and other data of the request message may respectively correspond to a name and factor of the call method, and other data necessary for performing the call method.

Additionally, a type of a request message may be divided into Persist, Commit, Cancel, Read, or Command. Persist indicates a request message type causing performance of a call method included in the corresponding request message to be prepared. Commit indicates a request message type causing a change of a database state to be completed according to a corresponding command, when a call method, included in a corresponding request message, is a predetermined command in a preparation stage of a current state change by the previous Persist request message, and the predetermined command causes a state change of the database.

Cancel indicates a request message type causing a corresponding command to be canceled, when a call method, included in a corresponding request message, is a predetermined command in a preparation stage of a current state change by the previous Persist request message.

Read indicates a request message type causing a call method included in the corresponding message to read data stored in the database. Command, as a command not causing a state change of the database other than Commit, may include other information request regarding a present state of the database or data, and inclusively indicate other request messages except the above described 4 types.

The first DDS agent 212 searches for topics registered for the publisher 210 through the DDS interface 213 to transmit the converted request message to the subscriber 220, which is another node subscribed to the corresponding topics, through the DDS interface 213.

The subscriber 220 includes a DDS interface 221, a second DDS agent 222, and a database access interface 223.

The second DDS agent 222 receives the request message transmitted from the publisher 210 through the DDS interface 221.

And the second DDS agent 222 converts the corresponding request message into call methods included in an application programming interface (API) of the database access interface 223, and calls the converted call methods to control the database through the database access interface 223.

In the DDS according to the present embodiments, the topics and the database table may be formed to correspond to each other. Accordingly, the call methods may be called for the database table, which correspond to a topic of the corresponding request message. At this time, the database table is not limited to the database locally connected to the publisher 220, but may be a database remotely connected through the DDS network 230.

The second DDS agent 222 transmits a result of control processes of the database, through the database access interface 223, only to the publisher 210, which is the node having transmitted the received request message.

At least a portion of the user application 211, the first DDS agent 212, and DDS interface 213, which are components of the publisher 210 according to the exemplary embodiments, and the DDS interface 221, the second DDS agent 222, and the database access interface 223, which are components of the subscriber 220, may be formed of software including at least one of an operating system, an application program module, and other program modules, and the software may be stored to various kinds of known storage devices. Meanwhile, these software modules include routines, subroutines, programs, objects, components and data structures, which perform specific tasks or execute a specific abstract data type that will be described later, but the exemplary embodiments are not limited thereto.

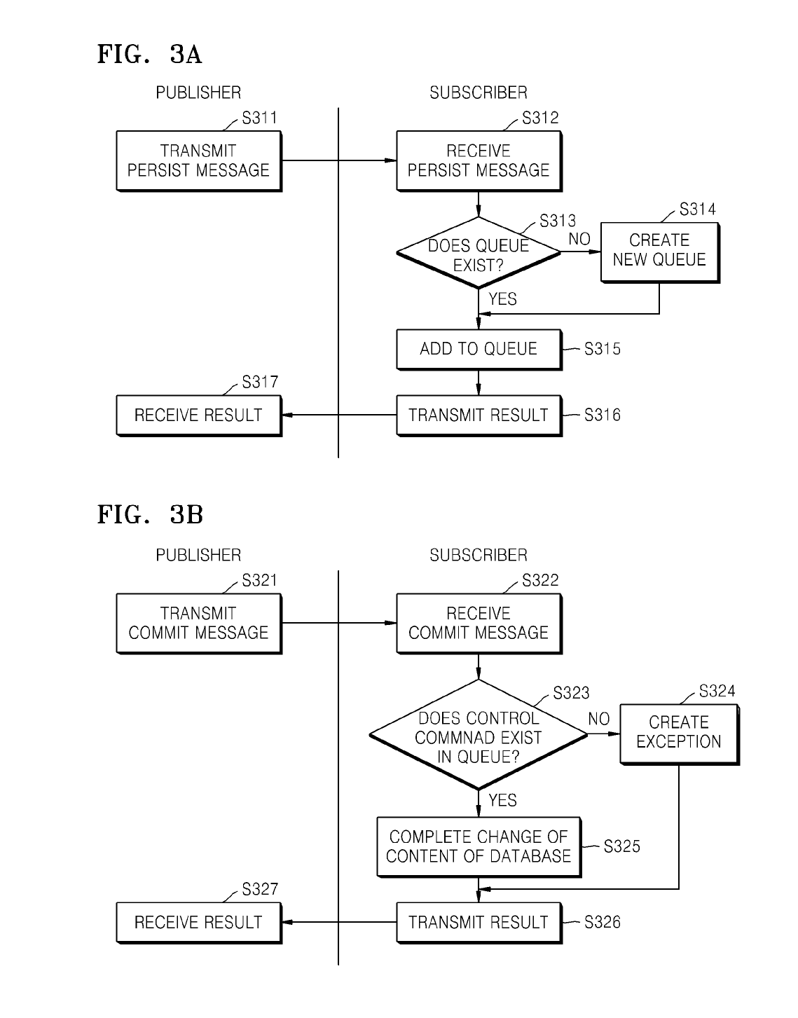

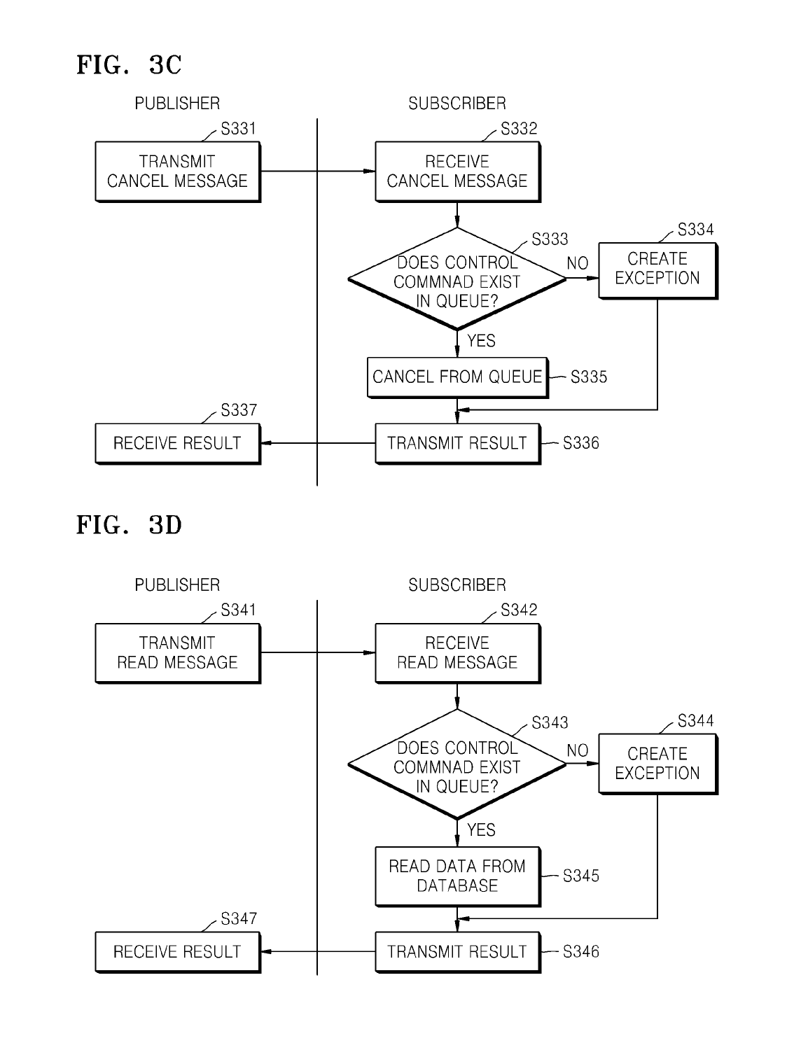

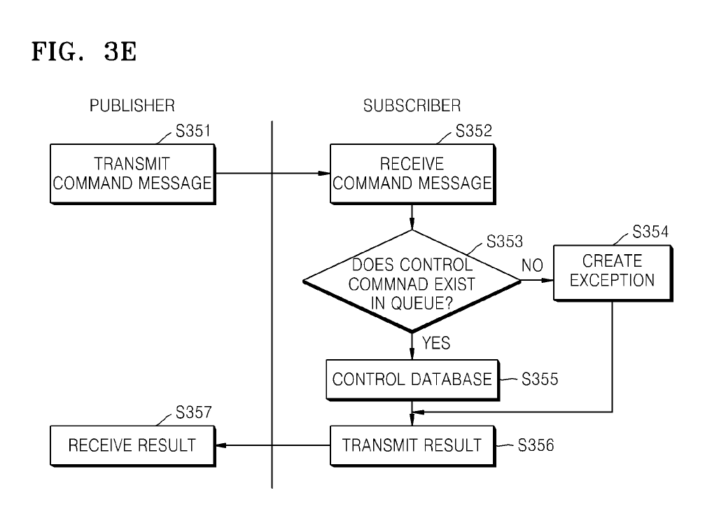

FIGS. 3A to 3E illustrate examples for controlling a database according to a request message type in DDS according to an embodiment.

Referring to FIG. 3A, when a request message type according to the present embodiment is “Persist”, a publisher transmits the Persist type request message to a subscriber registered for identical topics (operation S311). The subscriber receives the Persist type message (operation S312), and searches to determine whether a queue, corresponding to an identifier of the publisher which has transmitted the corresponding request message, and a database table indicated by the corresponding request message, exists (operation S313). When the queue does not exist, a queue corresponding to the publisher and the database table is created (operation S314).

The subscriber adds a database control command, included in the corresponding request message, to the queue which corresponds to the publisher and the database table (operation S315).

The operation result of S315 is transmitted to the publisher as a response to the received request message (operations S316 and S317).

Referring to FIG. 3B, when the request message type according to the present embodiment is “Commit”, a publisher transmits the Commit type request message to a subscriber registered for identical topics (operation S321). The subscriber receives the Commit type message (operation S322), and searches to determine whether a database control command included in the corresponding request message exists in a queue, which corresponds to an identifier of the publisher which has transmitted the corresponding request message, and a database table indicated by the corresponding request message (operation S323). When the database control command does not exist in the queue, an “Exception” is created (operation S324).

When the database control command exists in the queue, the database control command is performed on the corresponding database table, and content of the corresponding database table is changed (operation S325).

The operation result of S324 or S325 is transmitted to the publisher as a response to the request message received in operation S322 (operations 326 and S327).

Referring to FIG. 3C, when the request message type according to the present embodiment is “Cancel”, the publisher transmits the Cancel type request message to a subscriber registered for identical topics (operation S331). The subscriber receives the Cancel type message (operation S332), and searches to determine whether a database control command included in the corresponding request message exists in a queue, which corresponds to an identifier of the publisher which has transmitted the corresponding request message, and a database table indicated by the corresponding request message (operation S333). When the database control command does not exist in the queue, an “Exception” is created (operation S334).

When the database control command exists in the queue, the database control command included in the corresponding request message is canceled from the queue corresponding to the publisher and the database table (operation S335).

The operation result of S334 or S335 is transmitted to the publisher as a response to the request message received in operation S332 (operations 336 and S337).

Referring to FIG. 3D, when the request message type according to the present embodiment is “Read”, the publisher transmits the Read type request message to a subscriber registered for identical topics (operation S341). The subscriber receives the Read type message (operation S342), and searches to determine whether a data read command included in the corresponding request message exists in a queue, which corresponds to an identifier of the publisher which has transmitted the corresponding request message, and a database table indicated by the corresponding request message (operation S343). When the database control command does not exist in the queue, an “Exception” is created (operation S344).

When the database control command exists in the queue, data designated by the corresponding request message is read from the corresponding database table (operation S345).

The operation result (e.g., Exception or data read from the database) of S344 or S345 is transmitted to the publisher as a response to the request message received in operation S342 (operations 346 and S347).

Referring to FIG. 3E, when the request message type according to the present embodiment is “Command”, the publisher transmits the Command type request message to a subscriber registered for identical topics (operation S351). The subscriber receives the Command type message (operation S352), and searches to determine whether a database control command included in the corresponding request message exists in a queue, which corresponds to an identifier of the publisher which has transmitted the corresponding request message, and a database table indicated by the corresponding request message (operation S353). When the database control command does not exist in the queue, an “Exception” is created (operation S354).

When the database control command exists in the queue, the database control command is performed on the corresponding database table (operation S355). At this time, the database control command does not cause a state change of the database, differently from the Commit command, and may include other information request regarding the present state of the database or data.

The operation result (e.g., Exception or database control) of S354 or S355 is transmitted to the publisher as a response to the request message received in operation S352 (operations 356 and S357).

All of the type of request messages shown in FIGS. 3A to 3E may directly include information on the call method included in the API, which is embedded in the subscriber side, and in this case, each of the request message includes a name, a factor, and other data necessary to call the call method.

As described above, when method information on the call method is included in the request message, this method information may be added to or canceled from a queue, which corresponds to the publisher and the database table, the subscriber may call the call method included in the API according to the corresponding method information to perform a database change, a data read, and other control commands.

According to the exemplary embodiments, only a node requesting changing or updating a database, instead of all nodes subscribed to the DDS, can be notified of a result of the change or the update of the database, without affecting user applications using the DDS, when the database is changed or updated.

The method of managing a database in a DDS according to the exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage. The computer readable recording medium can also be distributed over network coupled computer systems, such that the computer readable code is stored and executed in a distributed fashion. Also, functional programs, codes, and code segments for accomplishing the exemplary embodiments can be easily construed by programmers skilled in the art to which the exemplary embodiments pertain.

While the exemplary embodiments have been particularly shown and described, it will be understood by those of ordinary skill in the art that various changes in form and details may be made therein without departing from the spirit and scope of the exemplary embodiments as defined by the following claims.

What is claimed is:

1. A system which manages a database in a data distribution service (DDS), in which a plurality of nodes connected to each other through a network are subscribed to the DDS for at least one topic, among a plurality of topics, the system comprising:
a first agent configured to be positioned at a first node, among the plurality of nodes, receive a control request for the database from a user application operating in the first node, and transmit the control request to at least one node subscribed to a topic registered for the first node;
a second agent configured to be positioned at a second node, receive the transmitted control request, control a database table according to the topic on a basis of the received control request, and transmit a result of controlling the database table to the first node.

2. The system according to claim 1, wherein the first agent is further configured to convert the control request into a request message of a format predefined on the DSS, and transmit the converted request message to the at least one node subscribed to the topic registered for the first node.

3. The system according to claim 2, wherein the request message comprises:
type information, which is information on a type of the request message; and
method information on a call method included in an application programming interface (API), which is embedded in the second node, the call method is allowed to be called by the second agent.

4. The system according to claim 3, wherein, when the request message type is persist, the second agent adds the method information to a queue, which corresponds to an identifier of the first node and the database table.

5. The system according to claim 3, wherein, when the request message type is commit and the method information exists in a queue, which corresponds to an identifier of the first node and the database table, the second agent performs a change on the database table corresponding to the topic according to the method information.

6. The system according to claim 3, wherein, when the request message type is cancel and the method information exists in a queue, which corresponds to an identifier of the first node and the database table, the second agent cancels the method information from the queue.

7. The system according to claim 3, wherein, when the request message type is read and the method information exists in a queue, which corresponds to an identifier of the first node and the database table, the second agent reads data stored in the database table corresponding to the topic according to the method information.

8. The system according to claim 3, wherein, when the request message type is command and the method information exists in a queue, which corresponds to an identifier of the first node and the database table, the second agent performs controls on the database table corresponding to the topic according to the method information.

9. The system according to claims 3, wherein the method information comprises a name and factor of the call method, and data necessary to perform the call method, which is included in the API and is allowed to be called by the second agent, the API being embedded in the second node.

10. The system of claim 1, wherein the second agent is further configured not to transmit the result of the controlling the database table to a node which has not transmitted the control request to the at least one node subscribed to the topic registered for the first node.

11. A method of managing a database in a data distribution service (DDS), in which a plurality of nodes connected to each other through a network are subscribed to the DDS for at least one topic, among a plurality of topics, the method comprising:
receiving, by a first agent configured to be positioned at a first node, among the plurality of nodes, a control request for the database from a user application operating in the first node;
transmitting, by the first agent, the control request to at least one node which is subscribed to a topic registered for the first node;
receiving, by a second agent configured to be positioned at a second node, the transmitted control request;
controlling, by the second agent, a database table corresponding to the topic on a basis of the received control request; and
transmitting a result of controlling the database table to the first node.

12. The method according to claim 11, wherein the first agent is further configured to convert the control request into a request message of a format predefined on the DSS, and transmit the converted request message to the at least one node subscribed to the topic registered for the first node.

13. The method according to claim 12, wherein the request message comprises:
type information, which is information on a type of the request message; and
method information on a call method included in an application programming interface (API), which is embedded in the second node, the call method is allowed to be called by the second agent.

14. The method according to claim 13, wherein, when the request message type is persist, the controlling comprises adding the method information to a queue, which corresponds to an identifier of the first node and the database table.

15. The method according to claim 13, wherein when the request message type is commit and the method information exists in a queue, which corresponds to an identifier of the first node and the database table, the controlling comprises performing a change on the database table corresponding to the topic according to the method information.

16. The method according to claim 13, wherein, when the request message type is cancel when the method information exists in a queue, which corresponds to an identifier of the first node and the database table, the controlling comprises cancelling the method information from the queue.

17. The method according to claim 13, wherein, when the request message type is read and the method information exists in a queue, which corresponds to an identifier of the first node and the database table, the controlling comprises reading data stored in the database table corresponding to the topic according to the method information.

18. The method according to claim 13, wherein, when the request message type is command and the method information exists in a queue, which corresponds to an identifier of the first node and the database table, the controlling comprises performing controls on the database table corresponding to the topic according to the method information.

19. The method according to claim 13, wherein, the method information comprises a name and factor of the call method, and data necessary to perform the call method, which is included in the API and is allowed to be called by the second agent, the API being embedded in the second node.

20. The method according to claim 11, wherein the second agent is further configured not to transmit the result of the controlling the database to a node which has not transmitted the control request to the at least one node subscribed to the topic registered for the first node.
